(19) United States
(12) Patent Application Publication
(10) Pub. No.: US 2026/0119795 A1
(43) Pub. Date: Apr. 30, 2026

(54) SYSTEM AND METHOD FOR CONVERSATION ANALYSIS BASED ON ARTIFICIAL INTELLIGENCE

(71) Applicant: SOGANG UNIVERSITY RESEARCH & BUSINESS DEVELOPMENT FOUNDATION, Seoul (KR)

(72) Inventors: Myoung-Wan KOO, Seoul (KR); Min Ju KIM, Seoul (KR); Heuiyeen YEEN, Incheon (KR)

(73) Assignee: SOGANG UNIVERSITY RESEARCH & BUSINESS DEVELOPMENT FOUNDATION, Seoul (KR)

(21) Appl. No.: 19/003,294

(22) Filed: Dec. 27, 2024

(30) Foreign Application Priority Data
Dec. 29, 2023 (KR) 10-2023-0196346

(51) Int. Cl. G06F 40/284

(52) U.S. Cl. CPC G06F 40/284

(57) ABSTRACT

Disclosed is a system for conversation analysis. More particularly, the present disclosure relates to a system and method for conversation analysis based on artificial intelligence that extracts a reliable basis through the analysis of spoken language text using artificial intelligence techniques. With the embodiments of the present disclosure, a language understanding technology and determination basis calculation model may be implemented in a pipeline to provide the basis along with the conversation analysis determination value, thereby enhancing user understanding and reliability of the technology.

### BACKGROUND

### 1. Technical Field

The present disclosure relates to a system for conversation analysis, and more particularly, to a system and method for conversation analysis based on artificial intelligence that extracts a reliable basis through the analysis of spoken language text using artificial intelligence techniques.

### 2. Related Art

In the field of artificial intelligence technology, a conversation understanding and classification system may be described as a technology that analyzes conversational text received as input to determine the label of the conversation. Recently, this conversation understanding and classification system has been implemented by fine-tuning pre-trained language models, which utilize deep artificial neural networks, for specific classification tasks. In addition, with the rapid development of Legal Tech, which combines law and technology, this application of artificial intelligence in the legal field has been continuously attempted.

However, since conventional methods of training deep artificial neural networks only display conclusions without providing explanations for the determinations, there is a reliability issue concerning the label, which is the result of artificial intelligence's determination. In particular, in legal systems that individually examine whether legal requirements are met to determine the legal effects, such black-box artificial intelligence technologies may not be suitable.

Accordingly, recent research has focused on methods to provide information on explainability to understand how artificial intelligence models work. Especially in the legal field, where reliability is of utmost importance, the application of explainable artificial intelligence is even more necessary.

However, there has been no publicly disclosed analysis model to date that extracts a reliable basis for the determination from the technology for understanding Korean language texts and applies the basis to the legal field. In particular, it may be seen that there has been no attempt to date to take a conversational text as input, analyze the conversational text, classify the result legally, and provide the basis therefor.

### PRIOR ART DOCUMENT

### Patent Document

Korean Patent No. 10-2574337 (Aug. 30, 2023)

### SUMMARY

Various embodiments are directed to addressing the reliability issues of analysis results in conversation analysis systems that only display conclusions without explanations for determinations, based on existing artificial intelligence technologies.

Furthermore, various embodiments are directed to providing a technology that, by fine-tuning a pre-trained language model with a transformer encoder structure, analyzes conversational texts related to threat contexts as desired by a user for legal classification, thereby determining an appropriate threat context classification label.

Furthermore, various embodiments are directed to providing a reliable basis for analysis results in the legal field by calculating the influence of each layer, deeply formed from the input of the artificial neural network to the output of the determination, and displaying the importance of each word from the threat context conversational text in the output, thereby extracting a determination basis and providing a reliable basis for the legal field.

A system for conversation analysis based on artificial intelligence according to an embodiment of the present disclosure may include a fine-tuning unit that trains a pre-trained language model using a first conversational text belonging to a plurality of specific context classes to generate a classification model through fine-tuning, a context classification unit that inputs a second conversational text to be analyzed, which is composed of a plurality of tokens, into the classification model to determine the specific context class to which the second conversational text belongs, and an influence determination unit that calculates influence information of a plurality of tokens on the determination result of the context classification unit for each layer constituting the classification model.

The pre-trained language model may be a transformer encoder-based language model.

The pre-trained language model may be Bidirectional Encoder Representations from Transformers (BERT).

The fine-tuning unit may perform training in such a way that a difference between a predicted label and an actual label generated by the pre-trained language model is minimized using a cross-entropy loss function.

The influence determination unit may use Layer-wise Relevance Propagation (LRP) algorithm to decompose a determination label for the specific context class at each hidden layer of the classification model, calculate contributions thereof, and redistribute relevance to previous hidden layers through relevance propagation to generate a basis for determination.

The system for conversation analysis based on artificial intelligence of the present disclosure may further include a text extraction unit that adds highlights to one or more tokens that have a contribution above a threshold based on the influence information.

The first conversational text may include one or more words belonging to one or more categories of legal threat contexts.

Furthermore, a method for conversation analysis using a system for conversation analysis based on artificial intelligence according to an embodiment of the present disclosure may include training a pre-trained language model using a first conversational text belonging to a plurality of specific context classes to generate a classification model through fine-tuning, inputting a second conversational text to be analyzed, which is composed of a plurality of tokens, into the classification model to determine the specific context class to which the second conversational text belongs, and calculating influence information of a plurality of tokens on a determination result of the specific context class for each layer constituting the classification model.

The pre-trained language model may be a transformer encoder-based language model.

The pre-trained language model may be BERT.

The training of the pre-trained language model using the first conversational text belonging to the plurality of specific context classes to generate the classification model through fine-tuning may include training in such a way that a difference between a predicted label and an actual label generated by the pre-trained language model is minimized using a cross-entropy loss function.

The calculating of influence information of the plurality of tokens on the determination result of the context classification unit for each layer constituting the classification model may include using LRP algorithm to decompose a determination label for the specific context class at each hidden layer of the classification model and calculating contributions thereof, and redistributing relevance to previous hidden layers through relevance propagation to generate a basis for determination.

After calculating influence information of the plurality of tokens on the determination result of the specific context class for each layer constituting the classification model, the method may further include adding highlights to one or more tokens that have a contribution above a threshold based on the influence information.

The first conversational text may include one or more words belonging to one or more categories of legal threat contexts.

With the embodiments of the present disclosure, a language understanding technology and determination basis calculation model may be implemented in a pipeline to provide the basis along with the conversation analysis determination value, thereby enhancing user understanding and reliability of the technology.

In addition, by individually examining the determination basis to determine the fulfillment of legal requirements, an effective usage environment is provided for introducing artificial intelligence technology in the legal field, where the determination of legal effects is required.

In addition, by visualizing and presenting fulfillment of legal requirements to the user, it becomes easier to identify the basis for a legally violent context through specific sentences or words in the conversation.

### BRIEF DESCRIPTION OF THE DRAWINGS

FIG. 1 is a diagram illustrating a system for conversation analysis based on artificial intelligence according to an embodiment of the present disclosure.

FIG. 2 is a diagram illustrating a method for conversation analysis based on artificial intelligence according to an embodiment of the present disclosure.

FIG. 3 is a table illustrating labeling criteria for text data used to train a pre-trained language model of a system for conversation analysis based on artificial intelligence according to an embodiment of the present disclosure.

FIG. 4 is a diagram illustrating a structure of a specific context class for classifying text data used in a system for conversation analysis based on artificial intelligence according to an embodiment of the present disclosure.

FIG. 5 is a table illustrating class-specific statistics of training data used for training a system for conversation analysis based on artificial intelligence according to an embodiment of the present disclosure.

FIG. 6 is a view illustrating a conversational text extracted by a system for conversation analysis based on artificial intelligence embodiment of the present disclosure.

### DETAILED DESCRIPTION

Embodiments of the present disclosure as described above are described in detail with reference to the accompanying drawings and embodiments.

It is to be noted that technological terms used in the present disclosure are used to describe only specific embodiments and are not intended to limit the present disclosure. Furthermore, the technological terms used in the present disclosure should be construed as having meanings that are commonly understood by those skilled in the art to which the present disclosure pertains unless especially defined as different meanings otherwise in the present disclosure, and should not be construed as having excessively comprehensive meanings or excessively reduced meanings. Furthermore, if the technological terms used in the present disclosure are wrong technological terms that do not precisely represent the spirit of the present disclosure, they should be replaced with technological terms that may be correctly understood by those skilled in the art and understood. Furthermore, common terms used in the present disclosure should be interpreted in accordance with the definition of dictionaries or in accordance with the context, and should not be construed as having excessively reduced meanings.

Furthermore, an expression of the singular number used in the present disclosure includes an expression of the plural number unless clearly defined otherwise in the context. In the present disclosure, terms, such as “include” and “comprise”, should not be construed as essentially including all various components or various s described in the present disclosure, but the terms may be construed as not including some of the components or steps or as further including additional components or steps.

Furthermore, terms including ordinal numbers, such as a “first” and a “second”, which are used in the present disclosure, may be used to describe various components, but the components are not restricted by the terms. The terms are used to only distinguish one component from the other components. For example, a first component may be named a second component without departing from the scope of rights of the present disclosure. Likewise, the second component may be named the first component.

Furthermore, the various techniques described in this specification may be implemented with hardware or software, or, when appropriate, with a combination of both. Terms such as “ . . . unit” and “ . . . system” as used in this specification may also be treated as equivalent to computer-related entities, including hardware, a combination of hardware and software, software, or software in execution. Furthermore, each function implemented in the system of the present disclosure may be composed of module-based programs and stored in a single physical memory or distributed and stored across two or more memories and storage media.

Hereinafter, preferred embodiments according to the present disclosure will be described in detail with reference to the accompanying drawings. The same reference numerals are given to the same or similar components regardless of reference numerals, and a repetitive description thereof will be omitted.

In the following description, the term “system for conversation analysis based on artificial intelligence” according to the embodiments of the present disclosure may be used interchangeably with “conversation analysis system” or “system”.

Hereinafter, a system and method for conversation analysis based on artificial intelligence according to embodiments of the present disclosure are described in detail with reference to the accompanying drawings.

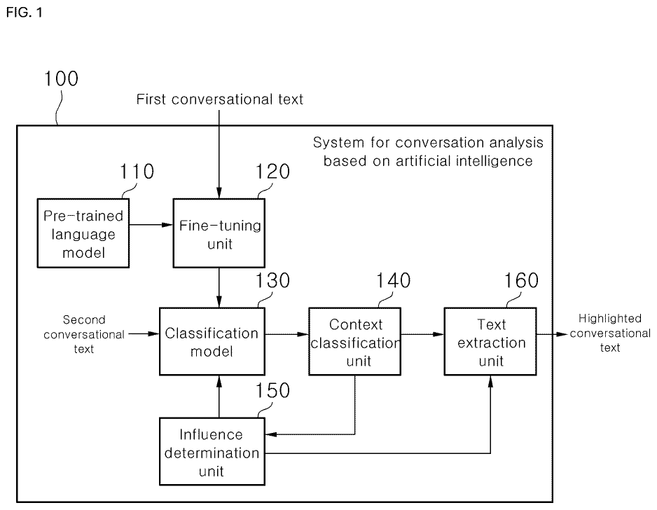

FIG. 1 is a diagram illustrating a system for conversation analysis based on artificial intelligence according to an embodiment of the present disclosure.

Referring to FIG. 1, a system for conversation analysis based on artificial intelligence 100 according to an embodiment of the present disclosure may include a fine-tuning unit 120 that trains a pre-trained language model 110 using a first conversational text belonging to a plurality of specific context classes to generate a classification model through fine-tuning, a context classification unit 140 that inputs a second conversational text to be analyzed into a classification model 130 to determine the specific context class to which the second conversational text belongs, an influence determination unit 150 that calculates influence information of a plurality of tokens on the determination result of the context classification unit 140 for each layer constituting the classification model 130, and a text extraction unit 160 that adds highlights to one or more tokens that have a contribution above a threshold based on the influence information.

The pre-trained language model 110 is a neural network model for natural language processing that learns context and meaning by tracking relationships within sequential data, such as words in sentences included in conversational texts. The attention mechanism may be applied to this model. This attention mechanism may perform analysis by determining which tokens among the plurality of tokens constituting the conversational text are associated with each other and which tokens are important in the overall conversational text, thereby generating vectors based on this determination.

A deep learning-based training model with a transformer encoder structure may be used as this pre-trained language model 110. For example, Bidirectional Encoder Representations from Transformers (BERT) may be used.

In particular, the BERT described above is known to have pre-training objectives, including predicting masked tokens in a text and determining the probability that one text segment follows another text segment.

The fine-tuning unit 120 may perform fine-tuning by inputting the first conversational text, which includes conversations classified as general conversation classes and those classified as legal threat contexts, into the pre-trained language model 110.

In particular, the fine-tuning unit 120 may perform training by comparing the threat context class, predicted by the pre-trained language model, with the actual threat context class and minimizing cross-entropy loss.

The cross-entropy described above is used to evaluate the performance of a language model by quantifying the difference between the probability distribution predicted by the language model and the actual probability distribution. A smaller value indicates that the two probability distributions are more similar.

This cross-entropy may be expressed by the following Equation 1.

$$cross entropy ( y ) = - {\sum }_{i} {y}^{′} log yi \qquad [ Equation 1 ]$$

In this case, y refers to the predicted label, and y′ refers to the ground truth label.

Therefore, the fine-tuning unit 120 may perform training in such a way that the difference between the predicted label and the actual label generated by the pre-trained language model is minimized using the cross-entropy loss function.

The classification model 130 is a designed language model that includes the pre-trained language model, which is fine-tuned by the fine-tuning unit 120 described above. When a conversational text is input, this classification model may generate and output determination labels for each token of the conversation.

The context classification unit 140 may perform analysis by inputting the second conversational text, which includes the conversation to be analyzed, into the classification model 130.

In particular, according to an embodiment of the present disclosure, the context classification unit 140 may generate determination labels for the tokens included in the second conversational text as the second conversational text is input into the classification model 130, and may determine whether the second conversational text belongs to a general conversation class or a legal threat context class through these determination labels.

In this case, the determination labels are classified according to legal interpretation, based on the events that occurred and the words used in the context inferred from the conversational text.

For the second conversational text analyzed by the context classification unit 140, the influence determination unit 150 may calculate influence information at each layer of the classification model 130, from the input of the artificial neural network to the output of the determination, based on the contribution of each token to the determination label.

Specifically, the influence determination unit 150 may reversely trace the classification model 130 with a transformer encoder structure from the output layer to the input layer and propagate the gradient and relevance of the attention matrix for each layer. This allows the influence determination unit 150 to measure the contribution to the determination values of the artificial neural network layers constituting the classification model 130. As a result, the influence determination unit 150 may measure the contribution of the tokens to the determination values of the classification model 130 and, accordingly, generate influence information that shows the degree to which each token contributed to the determination of the class of the second conversational text.

Specifically, according to an embodiment of the present disclosure, the influence determination unit 150 may use the Layer-wise Relevance Propagation (LRP) algorithm to decompose the determination label for the legal threat context class at each hidden layer of the classification model, calculate contributions thereof, and redistribute relevance to previous hidden layers through relevance propagation to generate the basis for determination.

The LRP algorithm described above is a backpropagation technique that derives the contribution affecting the result on a layer-by-layer basis. This algorithm is a technique that indicates which part of the classification model contributed to the result in the form of a heat map.

According to this LRP algorithm, it is possible to traverse the classification model in reverse from the prediction result to determine the contribution of each hidden layer. Through this, the contribution of each token constituting the second conversational text to the prediction result may be calculated.

The text extraction unit 160 may refer to the influence information described above to extract one or more tokens that have a contribution above a threshold from the tokens included in the second conversational text, and may highlight these tokens to visualize them within the conversational text.

In accordance with the configuration described above, the system for conversation analysis based on artificial intelligence according to the embodiment of the present disclosure utilizes a transformer encoder-based training model to determine the legal context class to which a conversational text belongs, appropriately classifies the conversational context, and visualizes the influence of which tokens among the plurality of tokens constituting each word or sentence included in the conversational text cause the conversational text to be classified into a specific context class, thereby enabling utilization as a legal basis for conversational text classification.

Hereinafter, a method for conversation analysis using a system according to an embodiment of the present disclosure is described in detail with reference to the accompanying drawings.

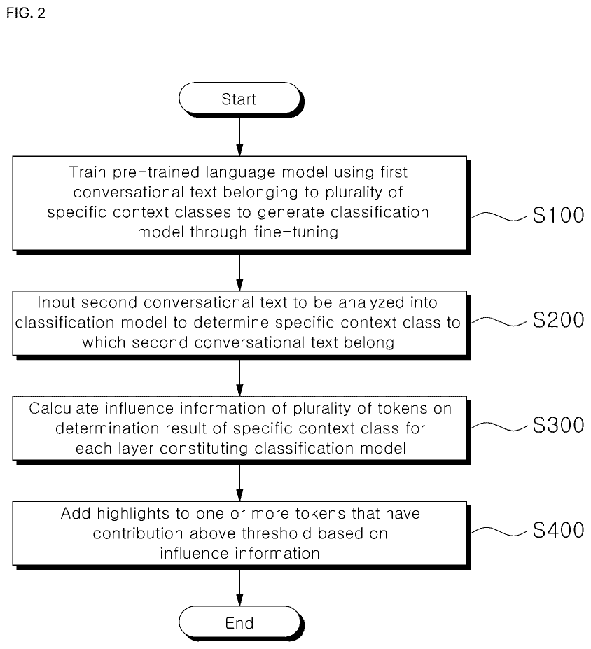

FIG. 2 is a diagram illustrating a method for conversation analysis based on artificial intelligence according to an embodiment of the present disclosure. In the following description, the entity executing each step, unless otherwise specified, refers to the system for conversation analysis based on artificial intelligence of the present disclosure and the components thereof.

First, the system for conversation analysis based on artificial intelligence according to the embodiment of the present disclosure prepares a transformer encoder-based pre-trained language model, performs pre-training using conversation data related to a plurality of specific contexts, such as a first conversational text classified as a legal threat, and performs fine-tuning the model to determine the category to which the conversational text to be analyzed belongs, thereby generating a classification model (S100).

In this case, the first conversational text may be composed of a total of five classes, one class for general conversation content and four classes for threat contexts according to legal interpretation. The system performs fine-tuning to enable the pre-trained language model to appropriately classify threat context classes according to legal interpretation using the first conversational text.

Next, the system inputs the second conversational text into the classification model generated in step S100 to analyze the conversation content and determine whether the text corresponds to the general conversation class or the threat context class from a legal perspective (S200).

Next, the system calculates the influence information of a plurality of tokens on the determination result of the specific context class for each neural network layer that constitutes the classification model (S300). If the second conversational text is determined as belonging to the threat context class, one or more of the plurality of tokens constituting the second conversational text may be considered as influencing the determination result. In this case, the system may use the LRP algorithm to calculate how much each token contributed to the determination of the threat context class and generate influence information accordingly.

Then, the system uses the influence information generated in step S300 to identify tokens with a contribution above a threshold and adds highlights to the corresponding text of those tokens in the second conversational text, thereby visualizing the basis for class classification (S400).

The technical concept of the present disclosure will be described in detail below with examples of classes used in the system for conversation analysis based on artificial intelligence according to the embodiment of the present disclosure.

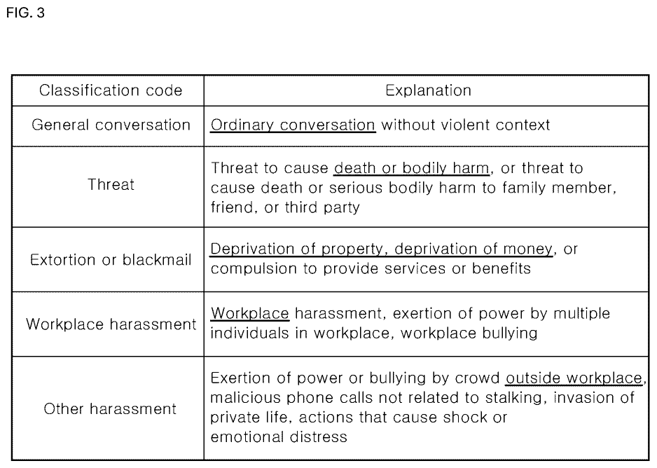

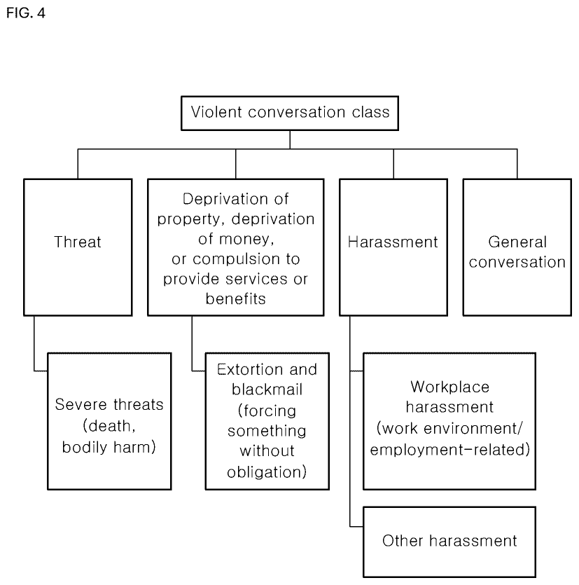

FIG. 3 is a table illustrating labeling criteria for text data used to train a pre-trained language model of a system for conversation analysis based on artificial intelligence according to an embodiment of the present disclosure. FIG. 4 is a diagram illustrating a structure of a specific context class for classifying text data used in a system for conversation analysis based on artificial intelligence according to an embodiment of the present disclosure.

Referring to FIGS. 3 and 4, the system according to the embodiment of the present disclosure applies multiple classes to the conversational text to be analyzed. The classes applied in the system may be divided into a total of five classes, one class for general conversation and four classes for threat contexts according to legal interpretation (threat, extortion or blackmail, workplace harassment, and other harassment). The system may be composed of a total of 21,874 conversations.

In this case, actual data (ground truth data) for the conversational context classes according to legal interpretation is secured through collaboration with legal experts in the process of constructing the determination labels for the data.

In addition, FIG. 4 hierarchically illustrates the structure of the threat context classes used in the present disclosure and provides an example of the criteria for constructing appropriate threat context labels for the conversational texts used in the system according to the embodiment of the present disclosure. The threat context labels described above refer to determination labels used to analyze and classify conversational texts according to legal interpretation, based on the events that occurred and the words used.

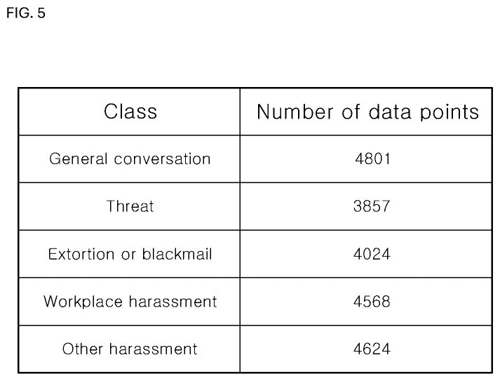

FIG. 5 is table a illustrating class-specific statistics of training data used for training a system for conversation analysis based on artificial intelligence according to an embodiment of the present disclosure. In the embodiment of the present disclosure, approximately 3,800 to 4,800 data points are used for threat context classes including general conversations.

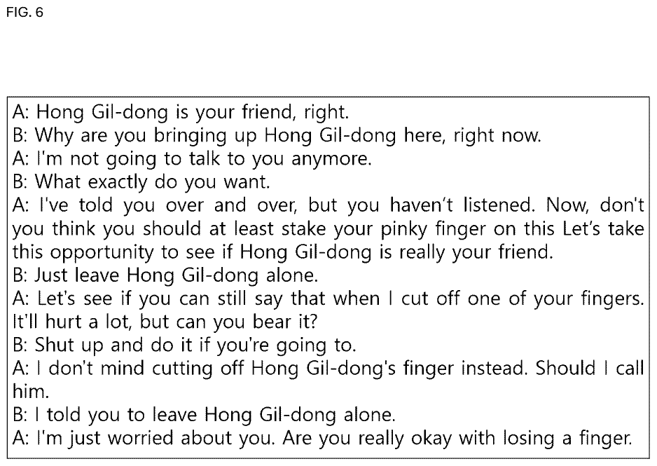

In addition, FIG. 6 is a view illustrating a conversational text extracted by a system for conversation analysis based on artificial intelligence according to an embodiment of the present disclosure. This view shows an example of a conversational text between two speakers (A, B) and classified as a threat class.

In the embodiment of the present disclosure, as the words (tokens) related to actions that cause serious bodily harm, which are the causes for classifying the conversational text into the threat class, are highlighted, it may be seen that the basis for the threat context within the conversational text is extracted.

In this case, the brightness of the highlight color may be determined in proportion to the contribution of each token, with a higher contribution resulting in a higher brightness of the highlight.

In accordance with these functions, the system for conversation analysis based on artificial intelligence according to the present disclosure may provide a legal basis for classifying a threat context in a conversation text by highlighting and displaying parts of the conversational text that cause physical and mental harm, which may lead to legal issues. This may be effectively used in legal analysis of conversational texts.

As a result, through the configuration described above, it is possible to automatically extract reliable bases within conversational texts, thereby securing portions that may serve as the basis for legal interpretation. This enables the implementation of explainability for legal determinations made by a language model and the reliability of the model's determination results.

Although many contents have been described in detail in the description, such contents should be interpreted as an example of a preferred embodiment rather than limiting the scope of the disclosure. Accordingly, the present disclosure should not be determined by the aforementioned embodiments, but should be determined by the claims and equivalents of the claims.

What is claimed is:

1. A system for conversation analysis based on artificial intelligence, the system comprising:
a fine-tuning unit that trains a pre-trained language model using a first conversational text belonging to a plurality of specific context classes to generate a classification model through fine-tuning;
a context classification unit that inputs a second conversational text to be analyzed, which is composed of a plurality of tokens, into the classification model to determine the specific context class to which the second conversational text belongs; and
an influence determination unit that calculates influence information of a plurality of tokens on the determination result of the context classification unit for each layer constituting the classification model.

2. The system of claim 1, wherein the pre-trained language model is a transformer encoder-based language model.

3. The system of claim 2, wherein the pre-trained language model is Bidirectional Encoder Representations from Transformers (BERT).

4. The system of claim 1, wherein the fine-tuning unit performs training in such a way that a difference between a predicted label and an actual label generated by the pre-trained language model is minimized using a cross-entropy loss function.

5. The system of claim 1, wherein the influence determination unit uses Layer-wise Relevance Propagation (LRP) algorithm to decompose a determination label for the specific context class at each hidden layer of the classification model, calculate contributions thereof, and redistribute relevance to previous hidden layers through a basis for relevance propagation to generate determination.

6. The system of claim 5, further comprising a text extraction unit that adds highlights to one or more tokens that have a contribution above a threshold based on the influence information.

7. The system of claim 1, wherein the first conversational text comprises one or more words belonging to one or more categories of legal threat contexts.

8. A method for conversation analysis using a system for conversation analysis based artificial intelligence, the method comprising:
training a pre-trained language model using a first conversational text belonging to a plurality of specific context classes to generate a classification model through fine-tuning;
inputting a second conversational text to be analyzed, which is composed of a plurality of tokens, into the classification model to determine the specific context class to which the second conversational text belongs; and
calculating influence information of a plurality of tokens on a determination result of the specific context class for each layer constituting the classification model.

9. The method of claim 8, wherein the pre-trained language model is a transformer encoder-based language model.

10. The method of claim 9, wherein the pre-trained language model is BERT.

11. The method of claim 8, wherein the training of the pre-trained language model using the first conversational text belonging to the plurality of specific context classes to generate the classification model through fine-tuning comprises training in such a way that a difference between a predicted label and an actual label generated by the pre-trained language model is minimized using a cross-entropy loss function.

12. The method of claim 8, wherein the calculating of influence information of the plurality of tokens on the determination result of the context classification unit for each layer constituting the classification model comprises:
using LRP algorithm to decompose a determination label for the specific context class at each hidden layer of the classification model and calculating contributions thereof; and
redistributing relevance to previous hidden layers through relevance propagation to generate a basis for determination.

13. The method of claim 12, further comprising, adding highlights to one or more tokens that have a contribution above a threshold based on the influence information after calculating influence information of the plurality of tokens on the determination result of the specific context class for each layer constituting the classification model.

14. The method of claim 8, wherein the first conversational text comprises one or more words belonging to one or more categories of legal threat contexts.
